(19) United States
(12) Patent Application Publication
(10) Pub. No.: US 2017/0102861 A1
(43) Pub. Date: Apr. 13, 2017

(54) Natural Language Creation Tool for Applications, and an End User Drag and Drop Site-Building Design Canvas for Viewing and Analyzing User Adoption

(71) Applicant: LiveTiles LLC, New York, NY (US)

(72) Inventors: Karl Redenbach, New York, NY (US); Simon Tyrrell, Howrah (AU)

(21) Appl. No.: 14/879,303

(22) Filed: Oct. 9, 2015

(51) Int. Cl. G06F 3/0484; G06F 17/22; G06Q 10/06; G06F 3/14; G06F 17/24; G06F 3/0482; G06F 17/21

(52) U.S. Cl. CPC G06F 3/04847; G06F 3/0482; G06F 3/04842; G06F 17/2247; G06F 17/211; G06F 3/14; G06F 17/24; G06Q 10/06393

(57) ABSTRACT

A method, computer program product, and system for creating a custom user interface for an enterprise portal. Natural language statements are created and then corresponding client-side code is sourced from a code library. The client-side code is then executed in a browser session against the target API(s) resulting in an updated user interface for the enterprise portal. Further, a method, computer program product, and system to create custom information architectures for enterprise portal web sites is provided. The structure or hierarchy of the enterprise portal is displayed and a user can add sites or subsites or modify existing sites or subsites. Corresponding scripts to the additions or modifications are retrieved and executed resulting in an updated portal structure or hierarchy.

### BACKGROUND

The present invention n generally relates to the interface presented to users of many types of applications including enterprise portals such as Microsoft SharePoint™, or other widely-used enterprise portals and application platforms from vendors such as SAP or Oracle. Enterprise portals are software products that offer authorized users a single point of access to view and manage company-wide information and software applications, such as intra-company communications, databases of transactions or other accounting information, company documents, and so on. These portals are generally intended to provide users with a unified interface to various enterprise software systems built at different times, for different purposes, and in different ways. The portals therefore typically employ web technologies including but not limited to HTML, CSS, JavaScript, and jQuery in order to send commands and information to and from these enterprise systems, and present the results to the user in a common design and format.

Previous to the widespread adoption of enterprise portals, software tools and data sources were typically scattered across multiple isolated systems within a company, and accessing and integrating information was a costly and difficult undertaking that was available to a limited number of employees. Enterprise portals have therefore become powerful and widely-used systems to cost-effectively increase the range of employees who can view, analyze, and share business data from across their company, thereby enhancing business performance.

However, most users of enterprise portals typically face an uninformative portal interface when first accessing and attempting to use an enterprise portal to collaborate with other users in creating and sharing information. In order to take advantage of the full potential of the portal, the user must first build out an information architecture identifying other users and assign them to groups, specifying the location of documents within various computer systems, and permitting other users or groups of users to view, modify, create, or delete various documents.

In addition, enterprise portals allow users to create and structure multiple web sites viewable by other enterprise portal users. These allow users within companies to create and share knowledge, analysis, and insight, both within their teams, departments, or business units, and between different parts of the same company. The creators and administrators of internal web sites accessed through the enterprise portal typically must have specialized knowledge of web tools to design and build them, and cannot easily obtain detailed data on whether and how other users are using the site.

The process of creating and maintaining an information architecture is time-consuming and requires expertise in the specific enterprise portal platform and the products incorporated within it. The challenges of creating an information architecture, and of managing the various sites and resources that compose it, limit the adoption of enterprise portals, particularly among smaller companies, and limits their use within the companies that have chosen to create and deploy enterprise portals.

In addition, many other types of applications present the user with an interface that may include different parts that allow the user to view or interact with other components within the application. Many such applications present the user with a default interface usually based upon the most widely used components of the application. However, for a particular user the default interface may contain irrelevant or unimportant components. Thus, the user may want to customize the user interface of the application to better serve the user.

### SUMMARY

The inventors have created tools for creating and editing applications including enterprise portal information architectures. As used herein the word “tool” includes, but is not limited to, a computer implemented method, computer program product or a system. The tools can be accessed through any computing device capable of running a software application, such as a web browser, that is compatible with enterprise portal servers and capable of accessing networked communications. These devices include but are not limited to a desktop computer, a laptop computer, a tablet computer, a smart phone, a set-top box, a smart television, a gaming device, or an augmented or virtual reality display device.

The inventors have created a user interface (“UI”) tool, employing a natural language based interface, to allow a non-expert user to build out an information architecture. The UI tool prompts the user to create a simple statement in natural language expressing the actions the user wishes to perform. The UI tool interprets the statement and performs the action in the enterprise portal and/or in its connected enterprise software systems. The UI tool then creates the information architecture by dynamically creating and provisioning web-based assets within the enterprise portal, and presents the results to the user. The UI tool can be used to define, group, and process multiple successive statements in larger combinations to perform more complex tasks.

The inventors have also created a site building design tool, so that users can view, create, and modify a hierarchy of internal enterprise portal web sites (including subsites and other site assets). The design tool includes a design canvas that presents the user with options to size and position data resources on the enterprise portal web site or other application, select the source and format of the static or dynamic information presented in the resources, and determine which other users or groups of users are able to view, modify, add, or delete information on the site. Other elements of the design tool enable the user to view statistics about how other users or groups of users employ the enterprise portal sites, by presenting the order, security, and usage of each site in a simple flow diagram presented on a web page. The user does not require specialized technical knowledge to understand and view the structure of complex enterprise portal solutions, such as those from companies such as SAP®, Oracle®, or Microsoft® that use common web technologies to process and display information to users.

The ability to create sophisticated and wide-reaching information architectures on complex enterprise portal systems, using collections of simple statements that are easily understood to users with minimal software training, and “drag and drop” visual interfaces that are intuitively designed and readily familiar to users of other software products, is a key advantage of the proposed method, computer program product or a system.

The UI tool offers users, especially enterprise portal users, a way to issue commands to applications such as an enterprise portal in the form of simple natural language statements. Natural language consists of common everyday human expressions that are clearly understood and familiar, and that present minimal difficulty for a non-technical user to create and comprehend, in contrast to specialized commands, procedures, or software languages that require users to possess advanced knowledge to successfully operate enterprise portals or other software.

Natural language statements consist of one or more components or parameters. In an exemplary example, a statement consists of a verb, a type of object, and an audience. A person of ordinary skill in the art would understand that numerous other components and syntaxes could be used for a statement. In the exemplary example, the verb takes the form of an action the user wishes to perform. The type of object takes the form of an information resource, document, or software application that may be operated through the enterprise portal. The audience refers to a set or subset of other intranet users or company employees with whom the user is permitted to interact on the enterprise portal. This can include individuals, preexisting sets of individuals already defined as groups in the enterprise system, or groups specified and created by the user.

The UI presents the user with a simple, interactive text-based tool that guides the user through the steps of defining verbs, types of objects, and audiences to build a statement. The UI tool can also connect to voice recognition, voice activation, and natural language communication platforms including but not limited to those used by Apple in its Siri software, Microsoft in its Cortana® software, Google in its Google Now software, and Amazon in its Alexa software, enabling the user to create statements using simple spoken commands.

The UI tool can be used to define and process multiple successive statements, and allows users to group these statements into collections called blueprints to achieve more complex tasks. The UI tool can save and share these blueprints so that the user can take the information architecture built for one enterprise portal and apply it to another enterprise portal in order to obtain the same results.

The UI tool can also take statements or blueprints created by a user in one instance of an enterprise portal, save the statements or blueprints, and apply the statements or blueprints to another instance of the same enterprise portal software, in order to repeat the user's actions. In this way, enterprise portals built in a conventional manner can be altered and reconfigured using the UI tool, without requiring recourse to complex or difficult procedures. For example, a user could write a natural language statement using the UI tool, creating a private group on a company's enterprise portal so that members could collaborate on a quarterly report for a marketing department. The user could then use the same statement to create a similar group elsewhere on the company's enterprise portal so that members could develop a report for a finance department.

The UI tool can also take statements created by a user in one instance or component of an enterprise portal, save the statements, and apply the statements to another instance or component of the same enterprise portal software, in order to repeat the user's actions. For instance, a statement written for the enterprise portal of company A could be saved and used on the enterprise portal of company B, provided that company B is using identical or compatible enterprise portal software.

Another possible application is that the proposed UI tool could take statements intended for use on one type of enterprise portal software and apply them to another type of enterprise portal software from a different software manufacturer. For instance, a UI tool statement written for use on an installation of SAP enterprise portal software could be saved and used on an installation of Oracle enterprise portal software. In this way, the proposed UI tool can facilitate the development of common third-party solutions to business problems encountered by various firms operating different enterprise portals.

The above examples used for the UI tool are illustrative only and are not intended to limit the invention. Persons of ordinary skill in the art would readily recognize that there are additional uses for the UI tool and the statements created by the UI tool.

The inventors have also created a site building design tool in the form of a design canvas UI that allows users to design sites. In an exemplary example this is accomplished by drag and drop operations on an enterprise portal web page. In an exemplary example, the site building design tool can be accessed from the site hierarchy view, so that the user can add, delete, editor, or arrange a hierarchy of enterprise portal sites based on the user's requirements. The design tool requires no knowledge of computer code or enterprise portal systems for the end user to employ the design tool to make changes to enterprise portal sites.

The site building design tool allows an end user to drag and drop a top level site, subsite or template from a toolbar when editing the design canvas in edit mode. When the user is in this edit mode, the user may add, delete, or rearrange existing items or new items in the hierarchy. When the user has completed the relevant changes to the hierarchy and structure of the enterprise portal site, they are able to save and submit the changes and automatically create new sites.

The enterprise portal sites and information architectures created by the UI tool and the site building design tool can also be connected to a machine learning system, so that the system can identify, recognize, and propose natural language statements to create new site structures and properties for a department. These machine learning systems may include third-party services and machine learning platforms, including but not limited to Dell Statistica™ and Microsoft® Azure Machine Learning, that offer data analysis and are capable of presenting their results in the form of natural language statements. Machine learning analysis will allow users to understand what sites and structures should be modified and created, based on the conclusions of a machine learning system that has observed and analyzed the user's enterprise portal sites and information architecture.

After creating or modifying sites or their hierarchy, the site building design tool enables users to see the order, security, and users of each site on a web page. The hierarchical order and relationships of each site can be presented as a simple flow diagram. This representation of the site hierarchy allows users to understand where their data assets (including documents and other data resources) exist in relation to other sites at the department or company level. This allows users to more easily understand how to define their collaborations with other users or departments. The security information can be presented as colors or text statements, to allow rapid visual confirmation of the user's chosen configuration of groups and permissions to access data. The site use can also be displayed as colors or text statements, and are defined by the user to reflect the company's key performance indicators. The methods, computer program products, and systems disclosed can be implemented and used in many types of computing environments. A person of skill in the art will readily recognize their use and be able to enable their use without undue experimentation in many types of computing environments. One particular computing environment is a distributive computing environment. Examples of computing environments for enterprise portal and software tools are disclosed in U.S. Pat. Nos. 9,053,238; 8,739,120 and 8,756,292 the disclosure of which is incorporated by reference in their entirety.

This summary is provided to introduce simplified concepts for a natural language creation tool and site building design tool for enterprise portals. The concepts are further described below in the Detailed Description and/or shown in the Figures. This summary is not intended to identify essential features of the claimed subject matter, nor is it intended for use in determining the scope of the claimed subject matter.

### BRIEF DESCRIPTION OF DRAWINGS

Examples of working with the UI tool are described with reference to the following drawings. The same numbers are used throughout the drawings to reference like features and components:

FIG. 1 illustrates the view of a user when first launching the UI tool.

FIG. 2 illustrates the view of a user when the user defines an action.

FIG. 3 illustrates the view of a user when the user has defined an action, and is defining the object type.

FIG. 4 illustrates the view of a user when the user has defined an action and an object type, and is defining the audience.

FIG. 5 illustrates the view of a user when the user has defined an action, an object type, and an audience for the first statement, and is defining an action for a second statement.

FIG. 6 illustrates the view of a user when the user has defined an action, and is defining the object type, for the second statement.

FIG. 7 illustrates the view of a user when the user has defined an action and an object type, and is defining an audience, for the second statement.

FIG. 8 illustrates the view of a user when the user has defined an action, object type, and audience for the second statement, and is now specifying a definition of the audience.

FIG. 9 illustrates the view of a user when the user is naming the definition of the audience.

FIG. 10 illustrates the view of a user when the user has named the definition of the audience.

FIG. 11 illustrates the view when the user is specifying the members of the audience.

FIG. 12 illustrates the view when the user has completed specifying the name, definition, and members of the audience for the second statement.

FIG. 13 illustrates the view of a user when the user has completed specifying verbs, types of objects, and audiences for three statements, and is ready to instruct the UI tool to save or build out the information architecture specified in the statements.

FIG. 14 illustrates options for saving and sharing statements and blueprints made with the site building design tool.

FIG. 15 illustrates an example of a hierarchy of enterprise portal sites and subsites.

FIG. 16 illustrates the user viewing the hierarchy of enterprise portal sites and subsites, and their level of use.

FIG. 17 illustrates the user viewing the most popular items on a site and the number of hits received by the site.

FIG. 18 illustrates the view of a user when viewing the hierarchy of enterprise portal sites and subsites on the design canvas, and adjusting the configuration of a subsite on the enterprise portal.

FIG. 19 illustrates the view of a user interacting with the site builder dialog box to drag and drop components onto the design canvas.

FIG. 20 illustrates the major steps of the process of using the UI tool to building enterprise portal sites using natural language.

FIG. 21 illustrates the major steps of the process of using the site building design tool.

### DETAILED DESCRIPTION

### UI Tool

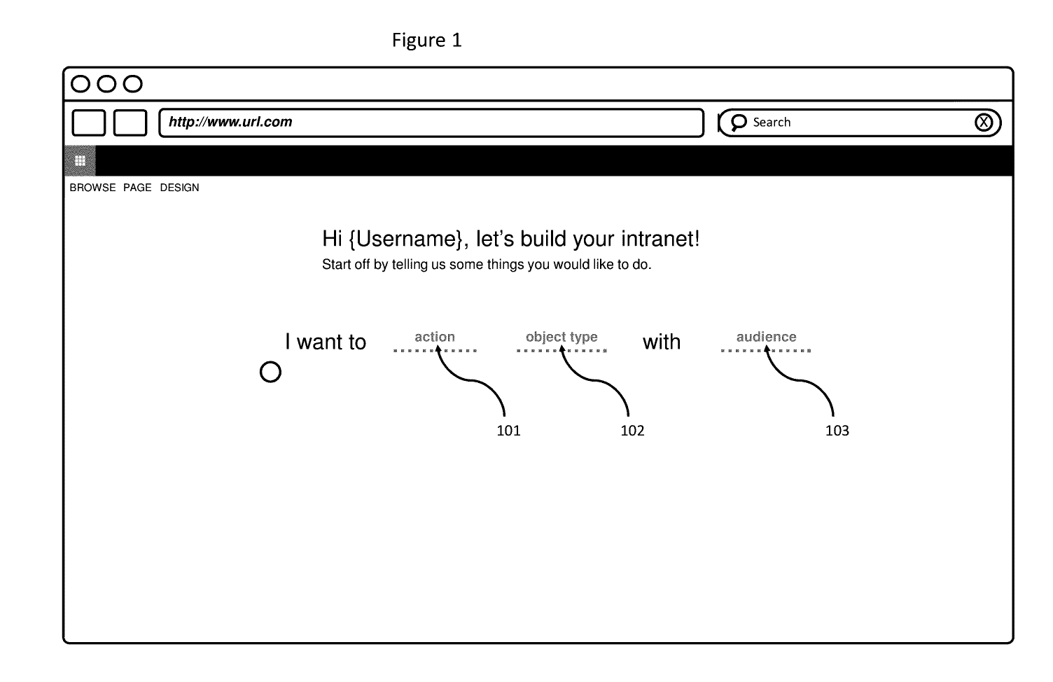

In the illustrative example of FIG. 1, the user has launched the UI tool and is preparing to define their first statement. The UI tool presents a basic statement to the user and asks them to select an action 101, a type of object 102, and an audience 103 for the statement. In the illustrative example, the statement consists of an action, an object and an audience. However, it is contemplated that the UI tool can be configured to have statements that consist of other components and syntaxes according the user's preference.

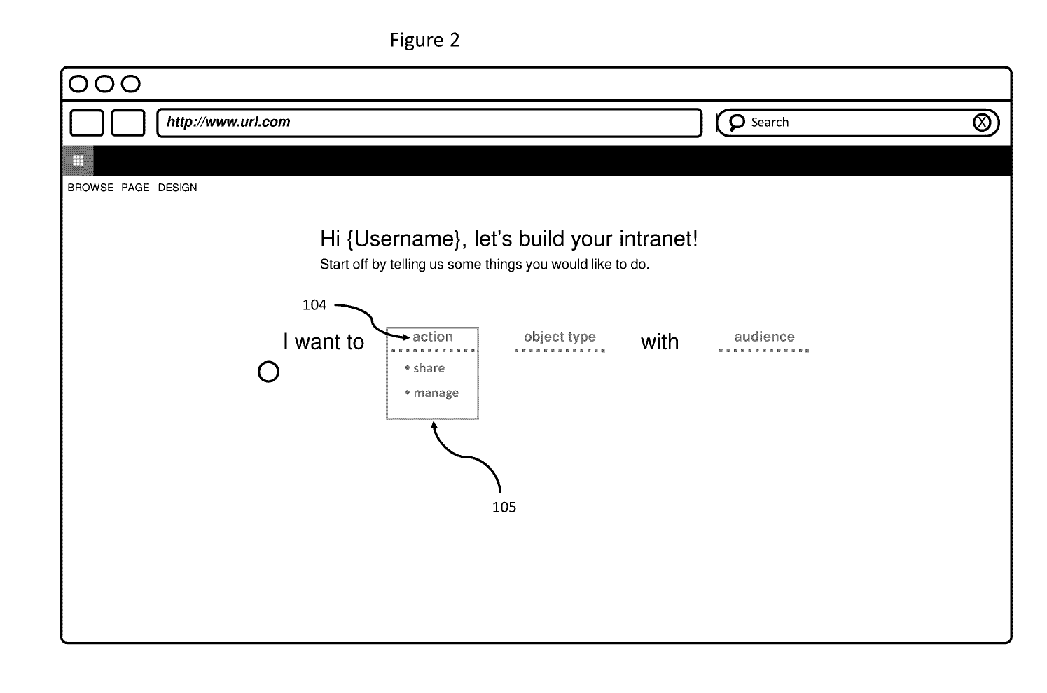

In the illustrative example of FIG. 2, the user is defining an action 104. The user has activated the word “action” within the statement, and the UI tool is presenting a drop-down list 105 of potential actions from which the user may make a selection. In this example, the UI tool is presenting a drop-down list offering the user the option to share or manage an object on the enterprise portal. There are numerous ways in which these options can be offered and selected that are contemplated to be within the invention. A person of ordinary skill in the art can select from among UI tool options using drop-down lists, menus, keystrokes, softkeys, icons and other known ways that allow UI tool options to be presented and selected.

The presentation of UI tool options for actions, types of objects, and audiences, is set by the tool by default. In an illustrative embodiment the UI tool will automatically populate the options for the user based on the target enterprise portal environment into which the UI tool is installed. The UI tool conceals the full range of options offered by the enterprise portal system, presenting a relevant subset of options to the user in order to simplify the use of the tool and avoid confusion. It is also envisioned to implement the UI tool in such a way that a user with administrative authority and a higher level of control over the enterprise portal system will be able to reconfigure the options presented to some or all users via a set of administrative configuration controls.

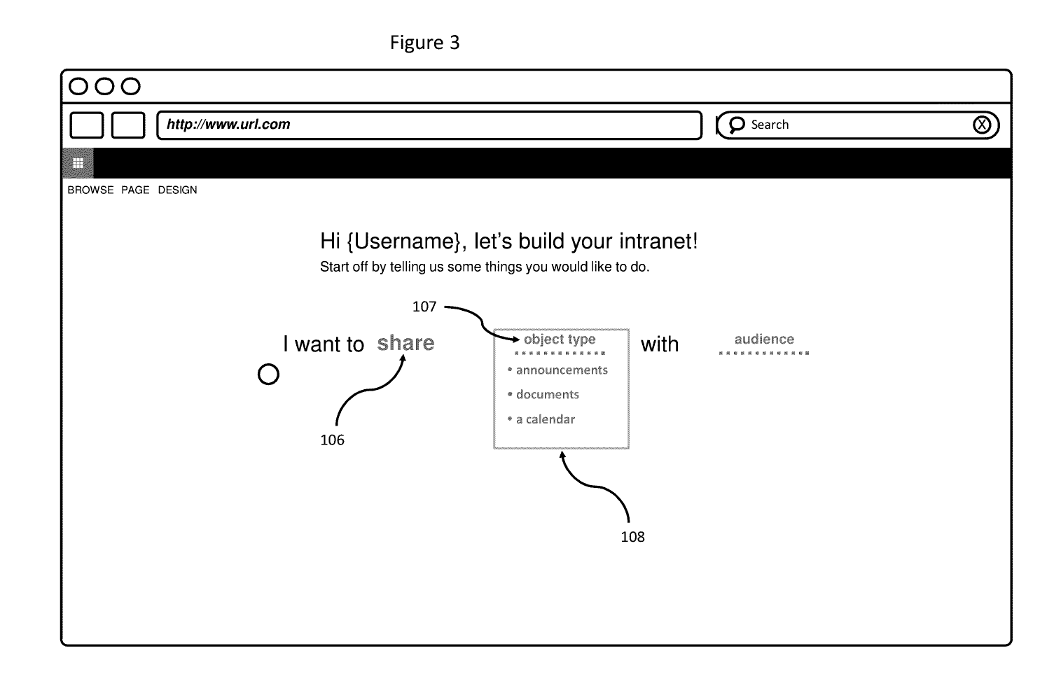

In the illustrative example of FIG. 3, the user has defined their desired action 106 as “share”, and is now defining the type of object 107 that they will share. The UI tool is presenting a drop-down list 108 of types of object, and the tool has defined the range of possible types of content in response to the user's earlier definition of the type of action the user wishes to perform. In this example, since the user has previously defined that they wish to share content, the UI tool is presenting a drop-down list offering the user options for three types of content that are commonly shared on an enterprise portal: announcements, documents, or a calendar.

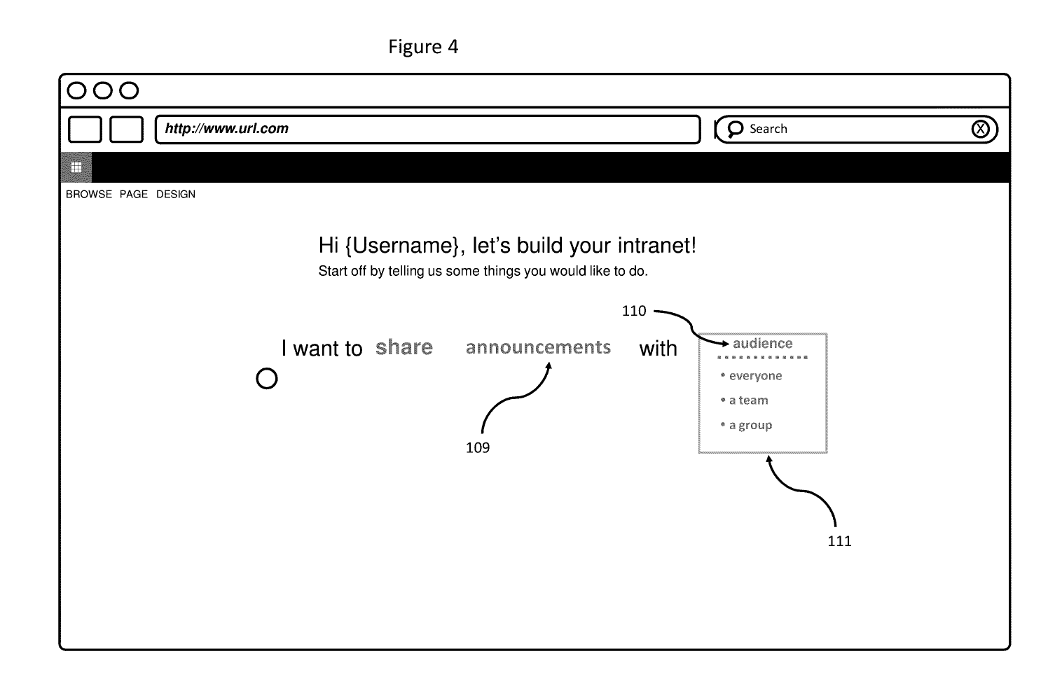

In the illustrative example of FIG. 4, the user has defined their desired action as “share”, defined their desired type of object 109 as “announcements”, and is now defining the audience 110 for the announcements they will share. The UI tool is presenting a drop-down list 111 of audiences, and the tool has defined the range of audiences in response to the user's access to other users of the enterprise portal. In this example, the UI tool is presenting a drop-down list offering the user the options to share announcements with everyone, a team, or a group on the enterprise portal.

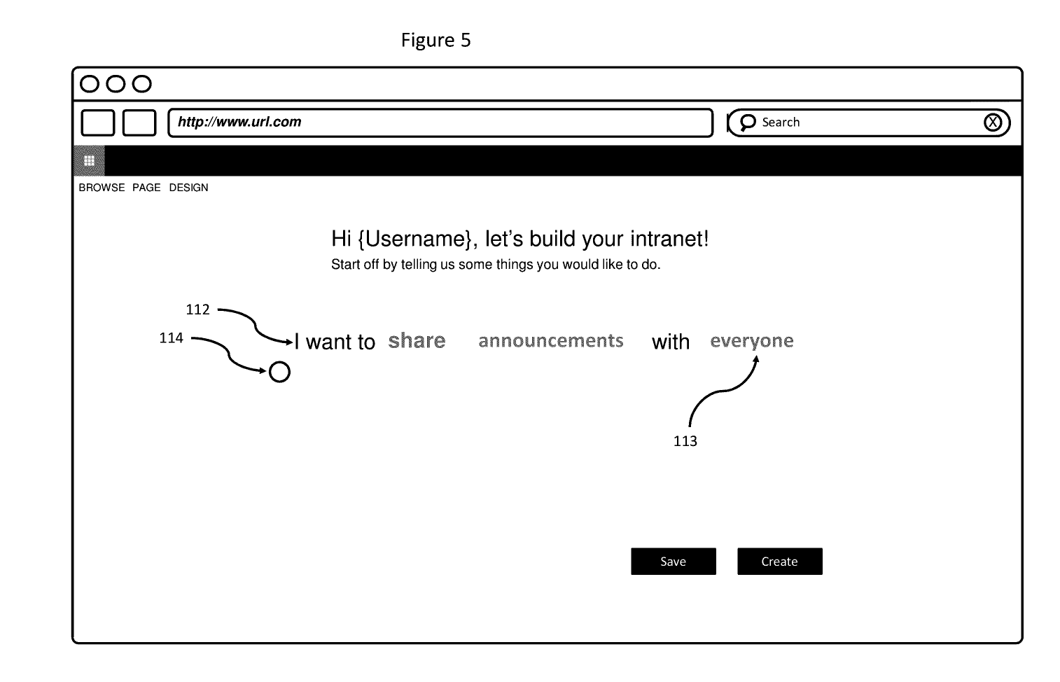

In the illustrative example of FIG. 5, the user has completed their first statement 112 by defining their desired action as “share”, defining their desired type of object as “announcements”, and defining their desired audience 113 as “everyone.” The first statement will therefore instruct the UI tool to select access privileges and procedures on the enterprise portal so that the content defined as announcements and generated by the user will be shared with everyone on the enterprise portal. The user is now activating a button 114 so that the UI tool adds a new, second statement, and the UI tool will offer the user the ability to define an action, type of object, and audience specific to the second statement. In creating multiple statements and instructing the UI tool to execute them together, the user is creating a blueprint or group of statements.

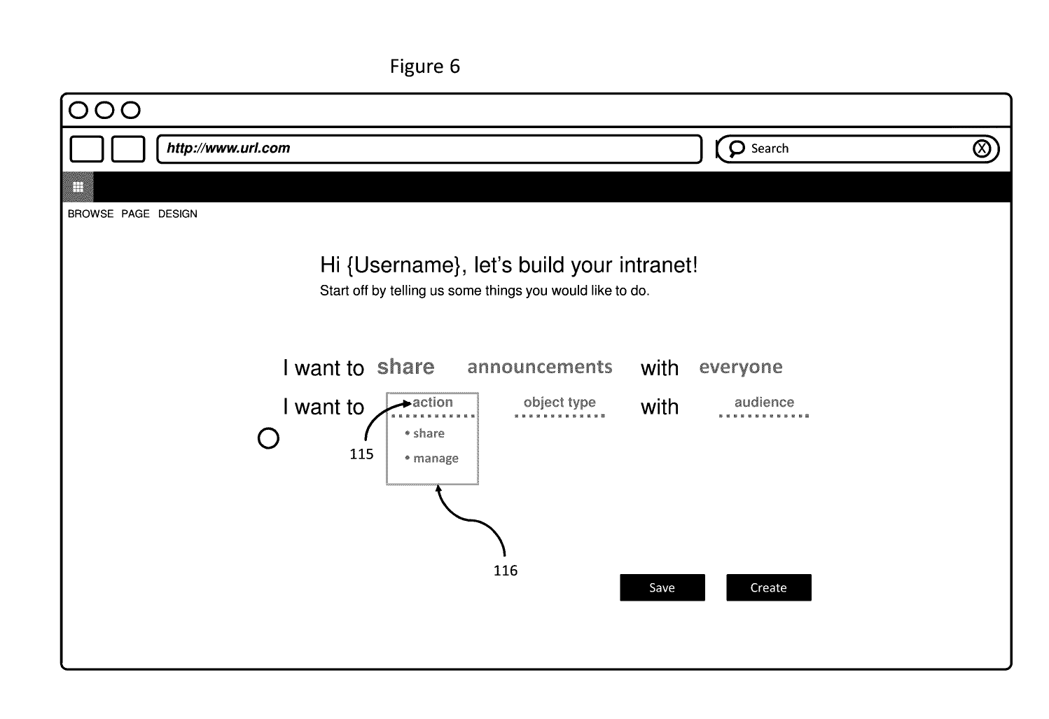

In the illustrative example of FIG. 6, the user is defining an action 115 for the second statement in the same manner as illustrated for the first statement in FIG. 2. The user has activated the word “action” within the statement, and the UI tool is presenting a drop-down list 116 offering the option to share or manage an object on the enterprise portal.

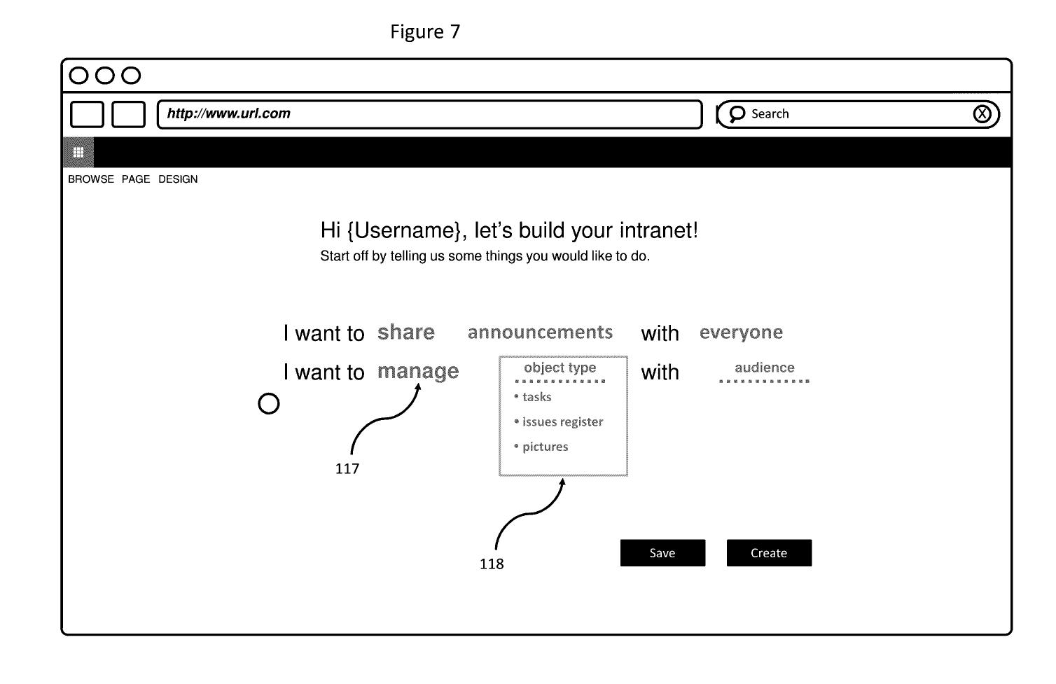

In the illustrative example of FIG. 7, the user has defined their desired action 117 for the second statement as “manage”, and is now defining the type of content that they will manage. Because the user defined their action as “manage”, the UI tool has defined a different range of possible types of content that the user may wish to manage. In this example, since the user has defined that they wish to manage content, the UI tool is presenting a drop-down list 118 offering the user options for three types of content that are commonly managed on an enterprise portal: tasks, an issues register, or pictures.

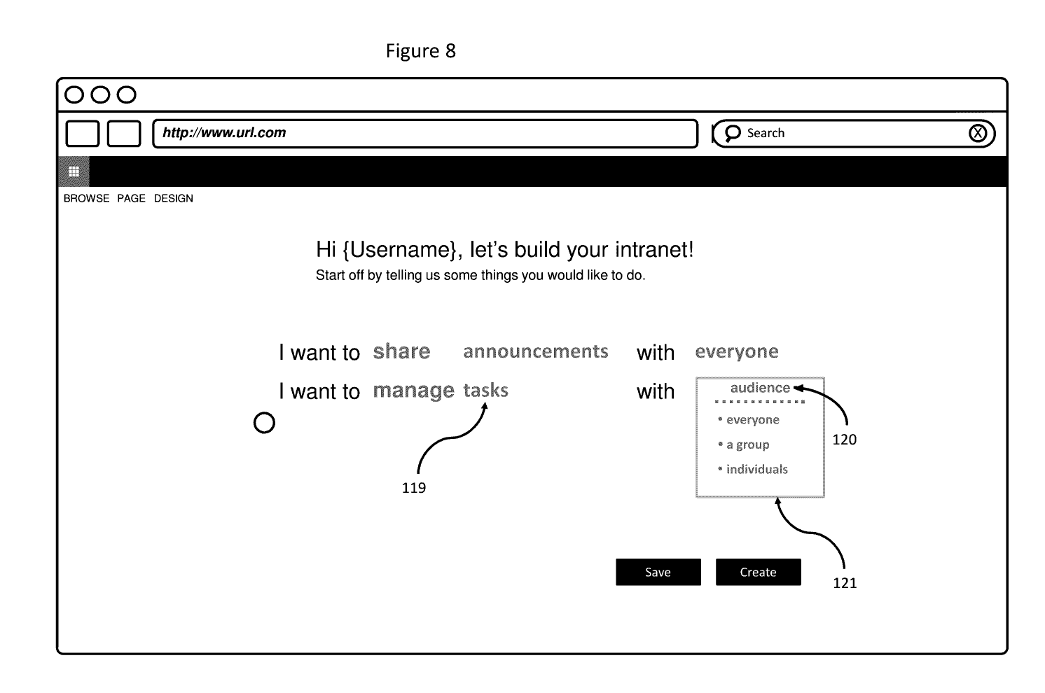

In the illustrative example of FIG. 8, the user has defined their desired action for the second statement as “manage”, defined their desired type of object 119 as “tasks”, and is now defining the audience 120 for the tasks they will manage. The UI tool is presenting a drop-down list 121 offering the user different types of audiences, and the tool has defined the range of audiences in response to the user's access to other users of the enterprise portal. In this example, the UI tool is offering the user the options to manage tasks with everyone, a group, or individual users on the enterprise portal.

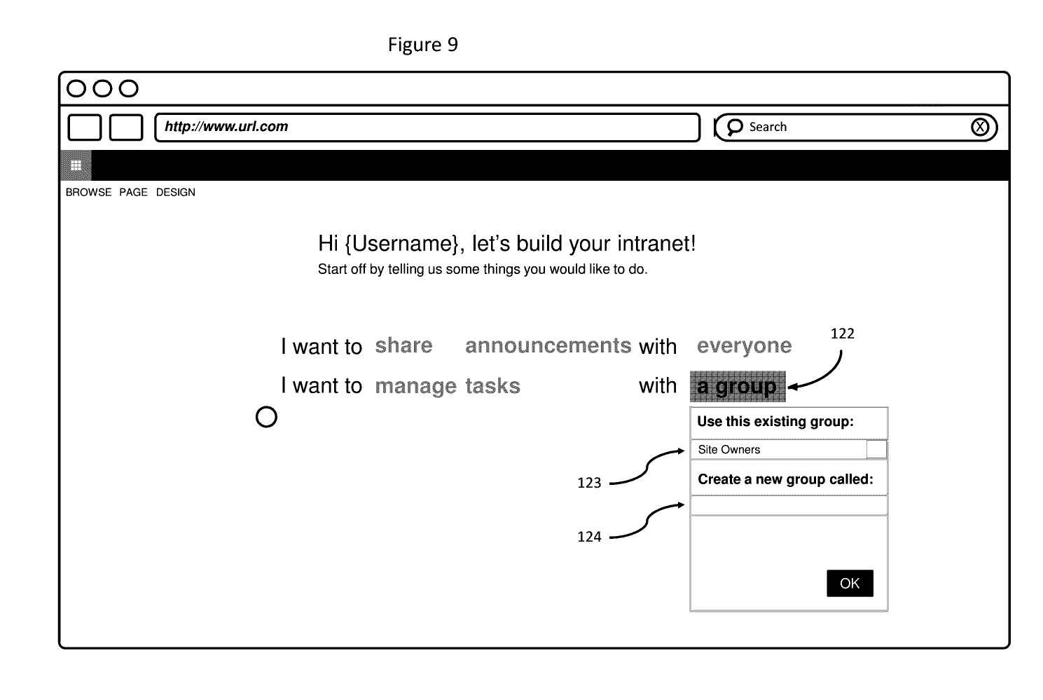

In the illustrative example of FIG. 9, the user has completed their second statement by defining their desired action as “manage”, defining their desired type of object as “tasks”, and defining their desired audience 122 as “a group.” The UI tool is now prompting the user to provide more information specifying the members of the group with whom tasks will be managed. The user may select from a pull-down list 123 of groups of users that have been previously defined on the enterprise portal, or may specify 124 that the UI tool create a new group.

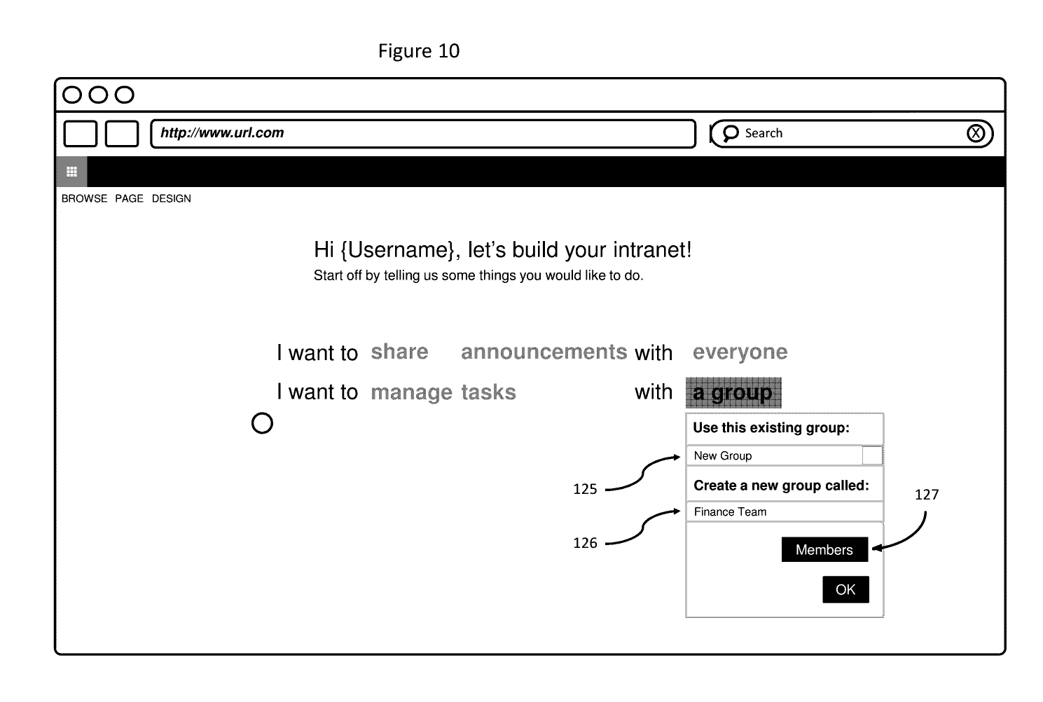

In the illustrative example of FIG. 10, the user has selected the option of specifying a new group 125 of enterprise users with whom tasks will be managed, and named the group “Finance Team” 126. The UI tool now prompts the user to specify the members of the group by presenting a button 127 labeled “Members”.

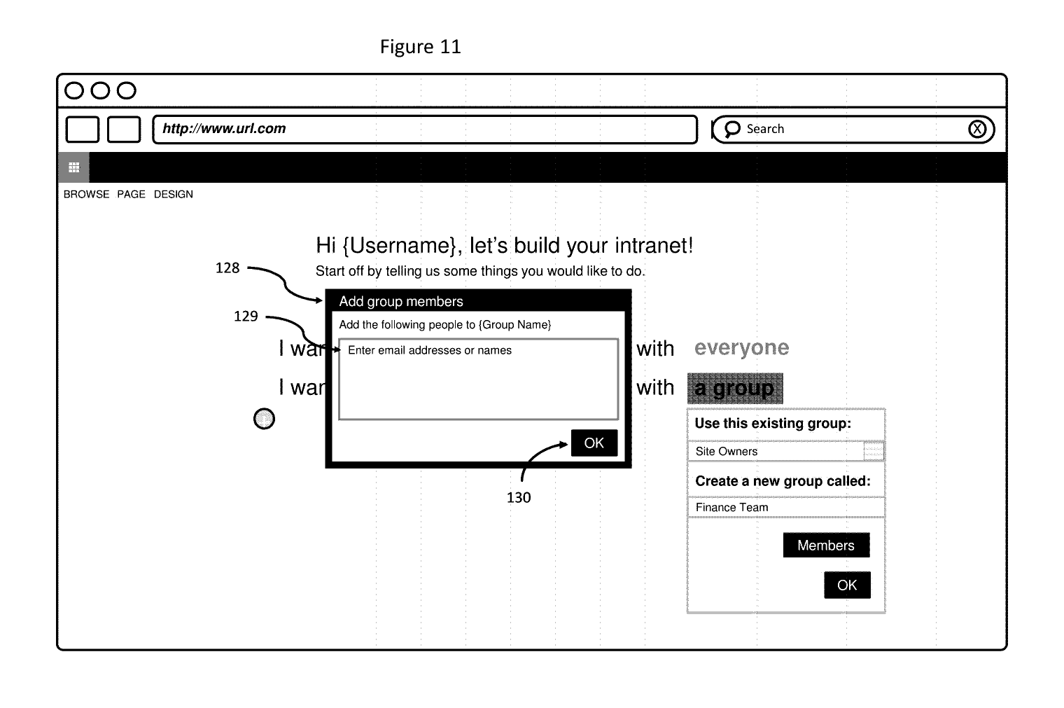

In the illustrative example of FIG. 11, the user has activated the “Members” button and is presented with a pop-up window 128 allowing them to input names or email addresses of the members of the Finance Team group into a form 129. When the user has finished adding names or email addresses to the list of Finance Team group members, the user will select the “OK” button 130. The UI tool and the enterprise portal software will then search for existing enterprise portal users based on the identifying information entered by the user, and add those users to the Finance Team group.

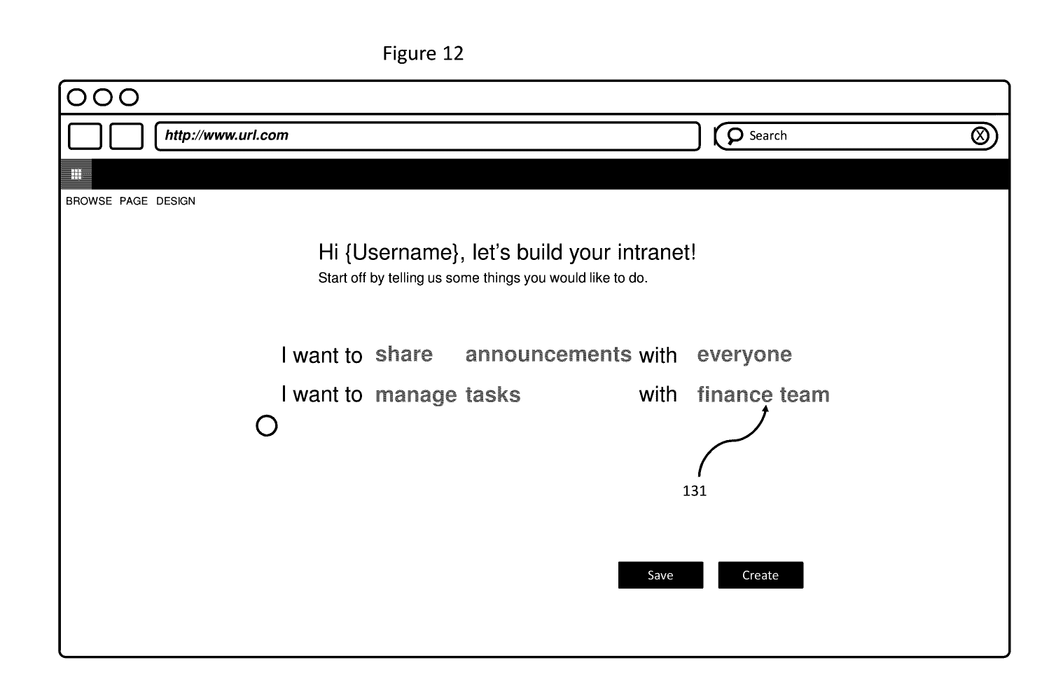

In the illustrative example of FIG. 12, the user has completed selecting members for the Finance Team group, and “finance team” has been defined as the audience 131 for the second statement.

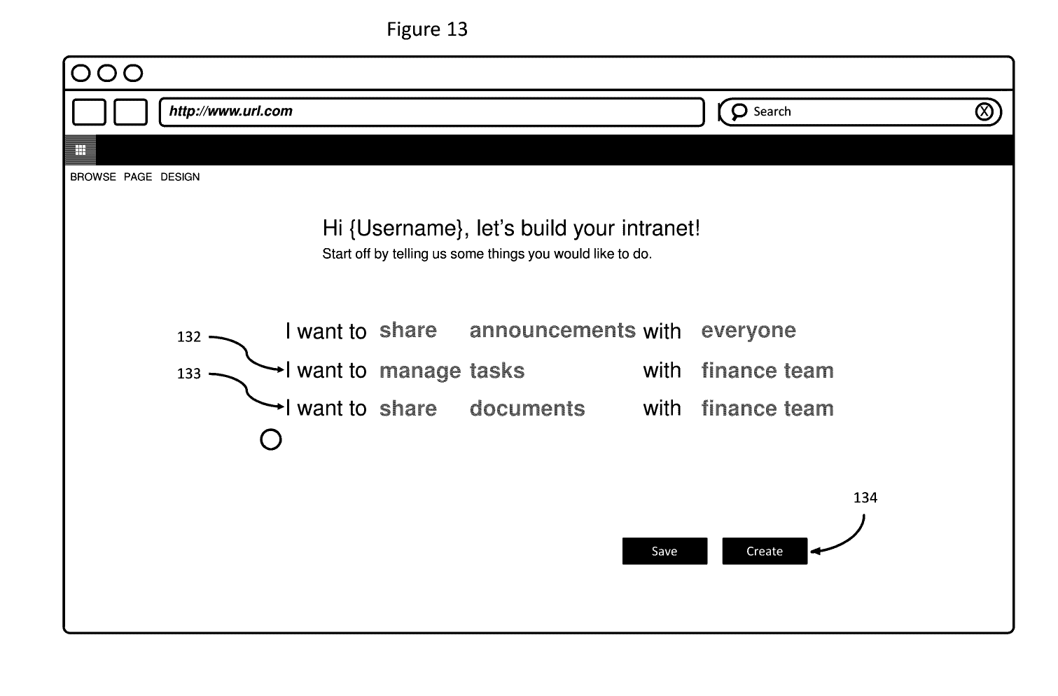

In the illustrative example of FIG. 13, the user has completed their second statement 132, and has added a third statement 133 to the blueprint by going through the same steps of defining a verb, type of object, and audience. These three statements form a blueprint instructing the UI tool to share the user's announcements with everyone on the enterprise portal; manage tasks with the members of the user-defined finance team, and now to share documents with the finance team. When the user activates the button labeled “Create” 134, the UI tool will run scripts to provision various web assets on the intranet portal, and thereby create the information architecture specified in the blueprint.

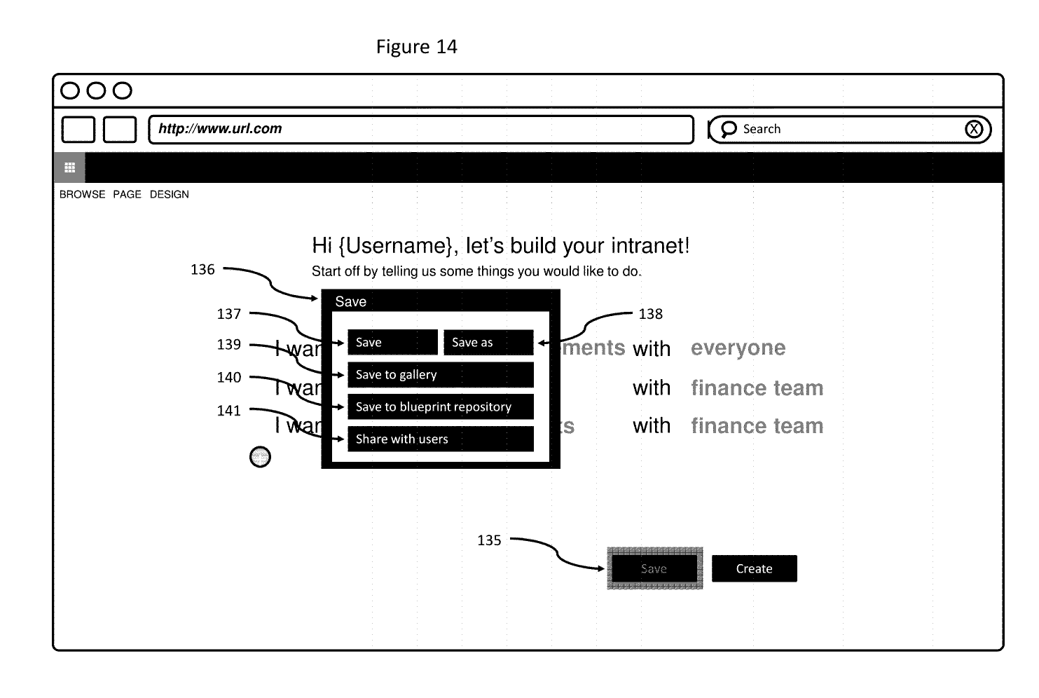

The illustrative example of FIG. 14 shows the results after the user has activated the button labeled “Save” 135, and the UI tool is presenting a window 136 of options for saving and sharing the blueprint completed by the user. The user may save the blueprint by activating the “Save” button 137, save the blueprint under a different name by activating the “Save as” button 138, save the blueprint to a gallery or list of commonly used blueprints easily available to the user or other users by activating the “Save to gallery” button 139, save the blueprint to a blueprint repository of other blueprints available to the user or other users by activating the “Save to blueprint repository” button 140, or share the blueprint with another user or group of users that the user may specify by activating the “Share with users” button 141. By offering multiple options for saving the blueprint in various locations and sharing it with other users, the UI tool facilitates the creation and sharing of information architectures and site structures, encouraging the use and enhancing the user experience of the enterprise portal software.

### Design Tool

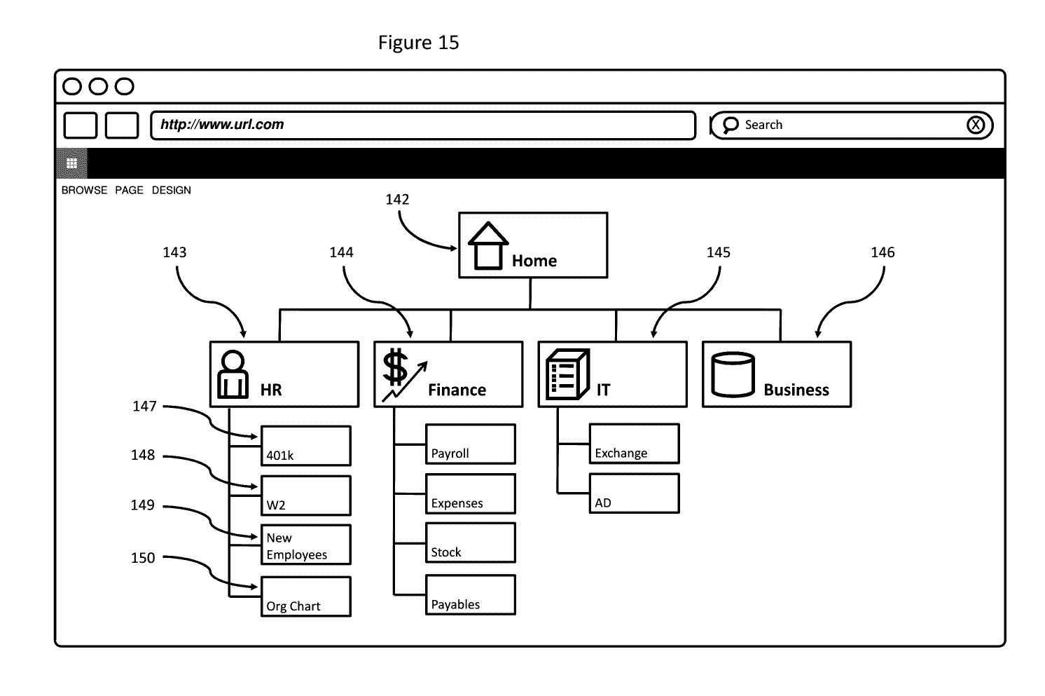

The illustrative example of FIG. 15 shows the “order” or structure of the various sites and subsites that make up the enterprise portal site. In this example, a home site 142 and four departments of a company are represented, including human resources 143, finance 144, information technology 145, and a business unit 146. In addition, the example depicts each department as having a set of subsites associated with their particular departmental functions. For example, the human resources site 143 is associated with subsites for functions such as 401k plans 147, W2 forms 148, New Employees information 149, and an Org Chart 150. The branching diagram shows the route by which a user would travel through the enterprise portal, starting at the home site or landing page 142 indicated by the house icon, and choosing to visit dedicated subsites for the various departments of the company. Each of those departmental subsites may have further subsites associated with them. There are numerous ways in which diagrams representing sites and subsites may be presented and interacted with that are contemplated to be within the invention. A person of ordinary skill in the art can view site structure and order information using block, cluster, flow, matrix, network, tree, and other known types of diagram, and select from among design tool options using clicks, drop-down lists, menus, keystrokes, softkeys, icons and other known ways that allow UI tool options to be presented and selected.

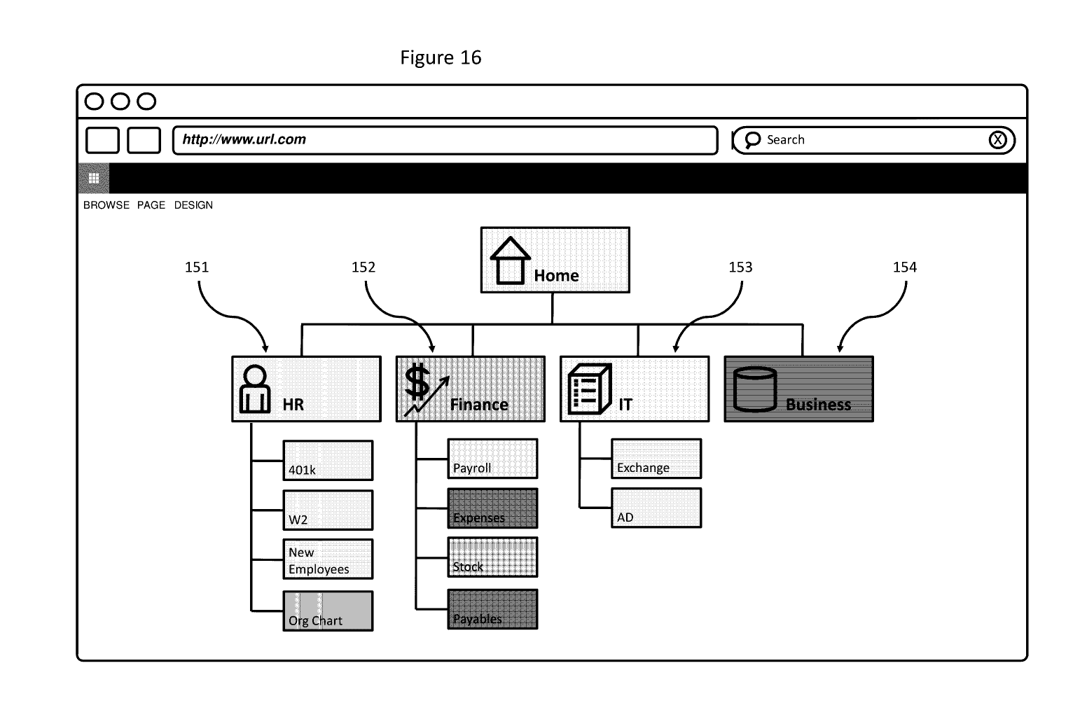

In the illustrative example of FIG. 16, the user is viewing the enterprise portal site hierarchy and viewing color-coded data about the use of each site or subsite. The colors may be configured to reflect the number of visitors to the site or subsite in a given period of time, the complexity of interactions the visitor has with the site or subsite, or other key performance indicators used by the company to assess the success of different departments or business functions. By allowing the user to view a simple visual summary of site usage and/or departmental performance, the design tool offers a powerful option for tracking business indicators and highlighting potential problems. In this example, with the colors represented as shades of gray, the sites for human resources 151 and information technology 152 are displayed in green, indicating good performance on the key performance indicator or indicators selected by the user for visualization; the site for finance 153 is displayed in orange, indicating medium performance; and the site for the business unit 154 is displayed in red, indicating poor performance.

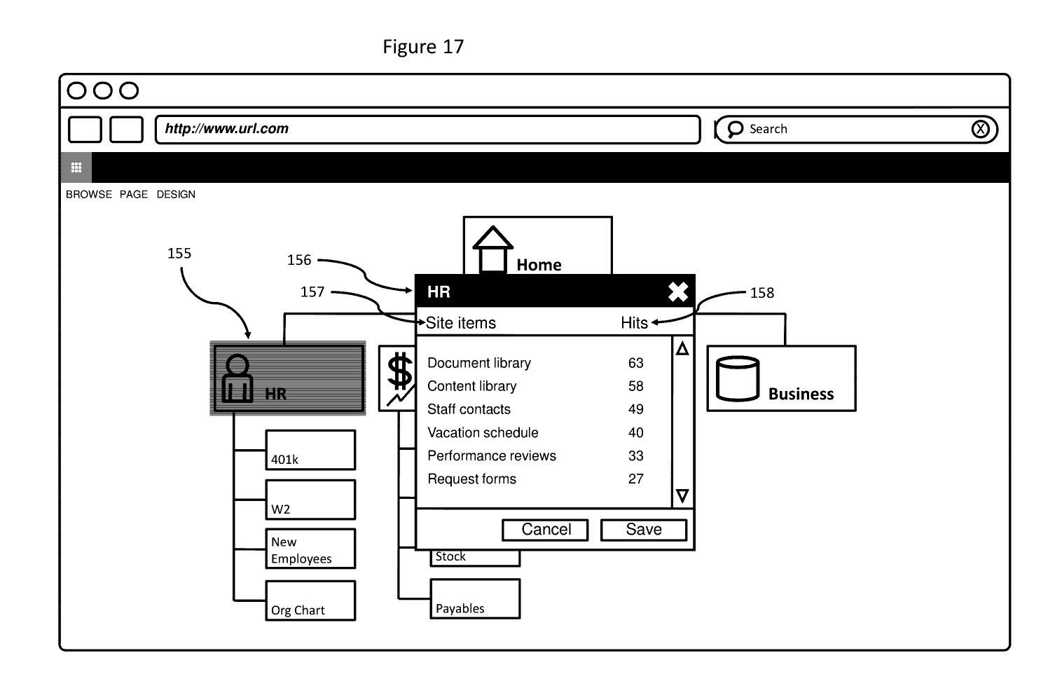

In the illustrative example of FIG. 17, the user is viewing the enterprise portal site hierarchy and a list of the most popular items on a particular site. The viewer has activated the icon representing the human resources site 155, which has spawned a window 156 listing the items available on the site 157 and the number of “hits” or visits each item has received in a given time period 158. The user can additionally select other information, reflecting site use or company key performance indicators, to view in this window in the column labeled “Hits” in this example. This complements the color-coded overview available in the illustrative example of FIG. 16 above, by permitting the user to view specific numerical data concerning particular sites, subsites, and items.

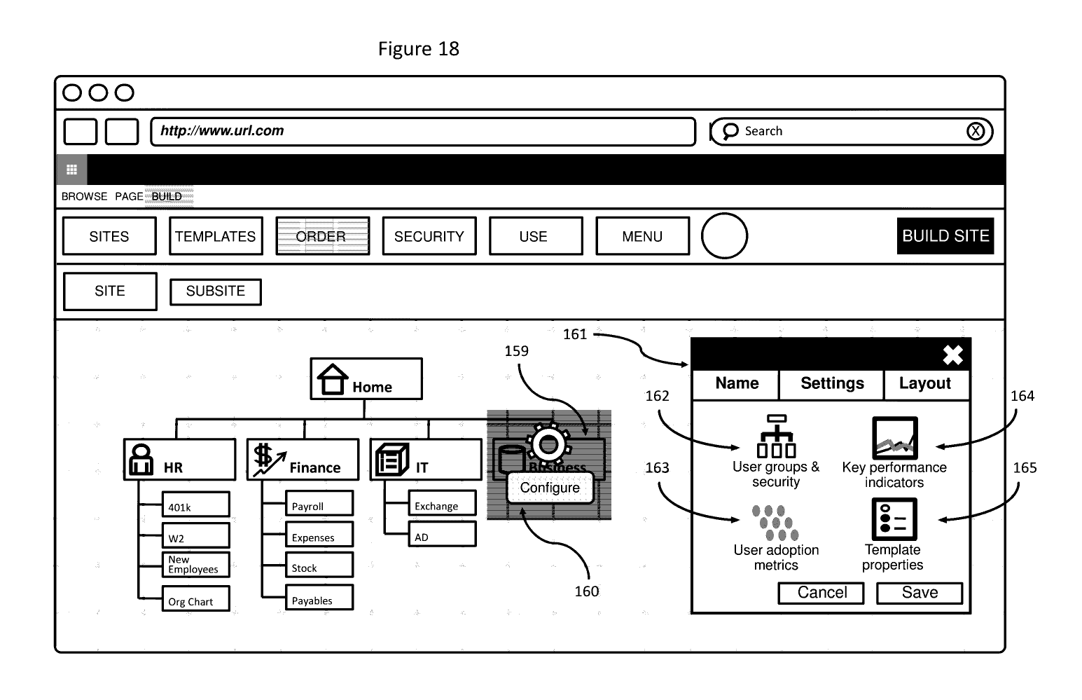

In the illustrative example of FIG. 18, the user is viewing the enterprise portal site hierarchy and configuring a subsite in the site building design tool. The design tool permits the user to enter a design/edit mode in order to reconfigure sites and subsites to reflect changes in the organization of corporate functions or the location of information resources within the enterprise portal. The configuration options in design/edit mode allow the user to change properties based on a non-technical form without the knowledge of code.

By right-clicking or otherwise carrying out an alternate interaction with the icon representing the “Business” subsite 159, the user has invoked a “Configure” button and icon overlay 160, and spawned a configuration dialog box 161. The dialog box offers the user multiple options to configure and view information about the “Business” subsite, including the users, user groups, and security permissions 162 associated with the site; key performance indicators 163 used in this company to assess the performance of its departments and business units, represented by text descriptions or color coding that indicates whether the site is used; user adoption metrics 164 showing how frequently users interact with the “Business” subsite; and the properties associated with page and site templates for the subsite 165, including options for configuring the visual appearance of the subsite to conform with branding or other graphics standards.

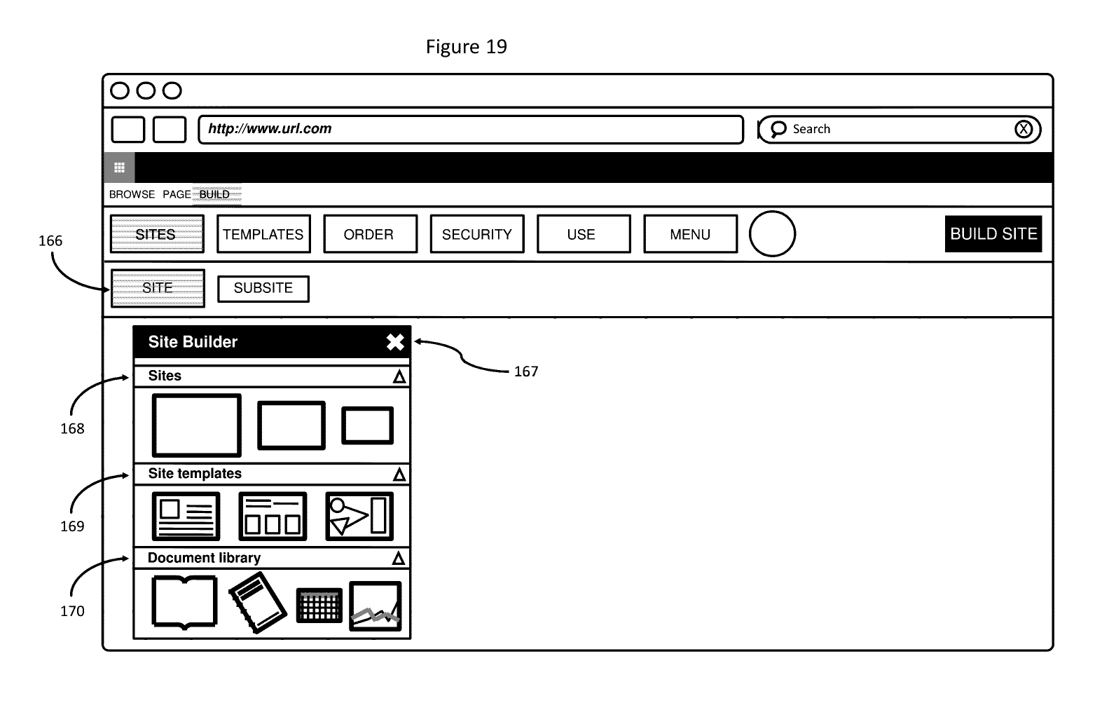

In the illustrative example of FIG. 19, the user has activated the “site” button 166 and is preparing to configure a new enterprise portal site using drag-and-drop tools. A “site builder” window 167 has appeared on the design canvas, offering the user options including what type of site 168 to build; pre-designed templates 169 for various site layouts and types; and a document library 170 of data resources with which the site may connect.

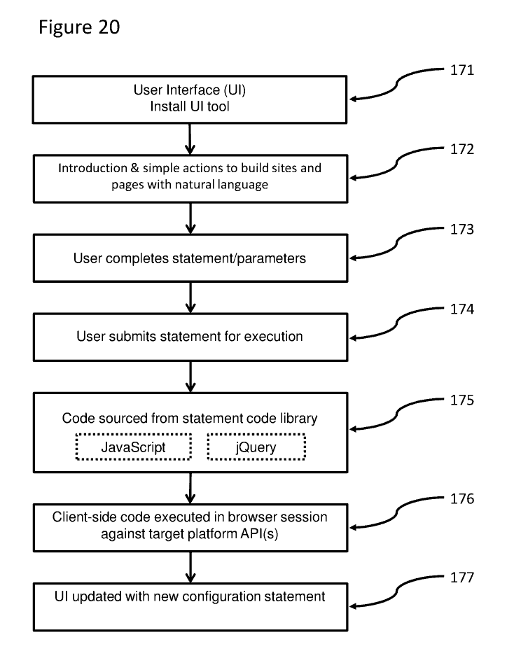

FIG. 20 illustrates the major steps of the process of using the UI tool to building enterprise portal sites using natural language. The user will begin in the user interface, and install the UI tool software 171. The user will then view a basic tutorial or introduction 172, including examples of how to start building out an information architecture on the enterprise portal site. In the illustrative example, the user will then select actions, types of objects, and audiences, and security permissions associated with the user-specified sites or data resources to complete a natural language statement or statements, which generates a set of parameters 173. The user will then click “Create” to submit the statement for execution by the UI tool 174. The UI tool includes a library of JavaScript and jQuery code corresponding to a range of particular configurations of statements, from which the tool selects the corresponding client-side code 175. The UI tool then executes the code in a browser session against the application programming interface or interfaces, commonly known as APIs, specific to the enterprise portal software in which the UI tool is operating 176. The user interface is then updated in the new configuration specified by the user statement or set of statements 177.

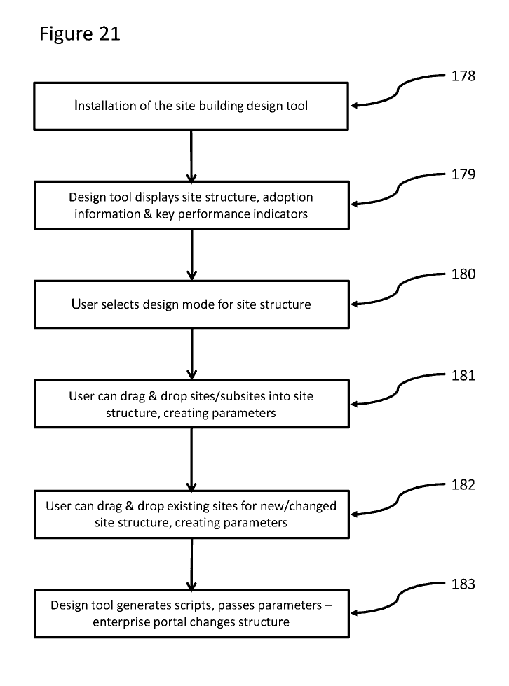

FIG. 21 illustrates the major steps of the process of using the site building design tool. The user will install the site building design tool software 178. The design tool then presents the site structure, and displays user adoption information and key performance indicators 179. The user will then select the design mode to employ the design canvas to create or adjust the site structure 180. The user can then drag and drop sites, subsites, and templates on to the design canvas to create a new structure, creating a set of parameters 181. The user can also drag and drop existing sites in a new configuration, to alter the site structure, also creating a set of parameters 182. When the user submits the new structure or their modifications to the existing structure, the design tool will then generate scripts to pass the parameters to the enterprise portal software, instructing it to create the selected sites and/or update the existing sites that have been altered by the user 183. In one embodiment of the design tool the generating of scripts corresponding to the desired addition or modification is accomplished by retrieving scripts associated with the modification or addition and associated with the particular application/enterprise portal web site from a library within the design tool. Alternatively, the design tool may contain a script generating engine similar to the pane engine of U.S. Pat. No. 7,165,215, the disclosure of which is incorporated by reference in its entirety.

1. A computer-implemented method for creating a custom user interface for an application using one or more natural language statements comprising:
displaying one or more statements containing one or more parameters;
accepting inputs for the one or more parts of the one or more statements;
retrieving from a code library the corresponding client-side code for the one or more statements; and
executing the retrieved code in a browser session against an application's programming interface or interfaces resulting in an updated user interface for the application.

2. The method of claim 1 wherein the parameters of the statement comprise a verb, a type of object, and an audience.

3. The method of claim 2 wherein the type of object is in the form of an information resource, document, or software application that may be operated through the enterprise portal and the audience refers to a set or subset of other intranet users or company employees with whom the user is permitted to interact on the enterprise portal.

4. The method of claim 1 wherein the application is an enterprise portal application.

5. The method of claim 1 further including a step of providing instructions and simple actions prior to displaying the one or more statements.

6. A computer program product for creating a custom user interface for an application using one or more natural language statements residing on a non-transitory computer-readable storage medium having a plurality of instructions stored thereon, which, when executed by a processor, cause the processor to perform operations comprising:
displaying one or more statements containing one or more parameters;
accepting inputs for the one or more parts of the one or more statements;
retrieving from a code library the corresponding client-side code for the one or more statements; and
executing the retrieved code in a browser session against an application's programming interface or interfaces resulting in an updated user interface for an application.

7. The computer program product of claim 6 wherein the parameters of the statement comprise a verb, a type of object, and an audience.

8. The computer program product of claim 6 wherein the application is an enterprise portal application.

9. A computer system comprising:
one or more processor devices; and
one or more memory architectures coupled with the one or more processor devices;
wherein the one or more processor devices are configured to:
display one or more statements containing one or more parameters;
accept inputs for the one or more parts of the one or more statements;
retrieve from a code library the corresponding client-side code for the one or more statements;
execute the retrieved code in a browser session against an application's programming interface or interfaces resulting in an updated user interface for the application.

10. The computer system of claim 9 wherein the parameters of the statement comprise a verb, a type of object, and an audience.

11. A computer-implemented method for creating a custom information architectures for an application comprising:
displaying an application's site structure;
presenting a design canvas allowing a user to add or modify the application's site structure;
accepting inputs for adding or modifying the site structure to create parameters; and
generating scripts to pass the parameters to the application instructing the application to create or modify the site structure.

12. The method of claim 11 wherein in addition to displaying the site structure additional information is displayed including user adoption information and key performance indicators.

13. The method of claim 11 wherein the application is an enterprise portal application.

14. A computer program product for creating for creating a custom information architecture for an application residing on a non-transitory computer-readable storage medium having a plurality of instructions stored thereon, which, when executed by a processor, cause the processor to perform operations comprising:
displaying an application's site structure;
presenting a design canvas allowing a user to add or modify the application's site structure;
accepting inputs for adding or modifying the site structure to create parameters; and
generating scripts to pass the parameters to the application instructing the application to create or modify the site structure.

15. The computer program product of claim 14 wherein the application is an enterprise portal application.

16. A computer-implemented method for displaying key performance indicators of an application program comprising:
visually displaying an application's site structure;
determining one or more key performance indicators for each site or subsite in the displayed site structure; and
indicating on the visually displayed site structure the one or more key performance indicators.

17. The method of claim 16 wherein the one or more key performance indicators is selected from the group consisting of the number of data assets in the site or subsite, security information for the site or subsite, the number of visitors to the site or subsite in a given period of time and the complexity of interactions the visitor has with the site or subsite.
